(19) United States
(12) Patent Application Publication
(10) Pub. No.: US 2010/0316120 A1
(43) Pub. Date: Dec. 16, 2010

(54) MOVING PICTURE CODING DEVICE AND BROADCAST WAVE RECORDING DEVICE

(76) Inventors: Kiyofumi ABE, Osaka (JP); Hiroshi Arakawa, Nara (JP); Tatsuro Juri, Osaka (JP); Kenjiro Tsuda, Osaka (JP); Hideyuki Ohgose, Osaka (JP)

Correspondence Address: WENDEROTH, LIND & PONACK L.L.P., 1030 15th Street, N.W., Suite 400 East, Washington, DC, 20005-1503, US

(21) Appl. No.: 12/814,734

(22) Filed: Jun. 14, 2010

(30) Foreign Application Priority Data
Jun. 15, 2009 (JP) 2009-141818

(51) Int. Cl. H04N 7/26

(52) U.S. Cl. 375/240.03; 375/E07.139

(57) ABSTRACT

A device coding a moving picture in units of a group including pictures, including: a generation unit generating quantization matrices; a selection unit selecting a quantization matrix for a current picture; a unit storing the quantization matrices in a header part of the group, and coding the current picture; a unit including a virtual buffer, and performing buffer simulation based on an amount of bits to be outputted; and a unit determining whether bit amount reducing is required for the current picture, based on a result of the buffer simulation, wherein the generation unit generates a normal quantization matrix used in common for at least one of the pictures, and a quantization matrix for bit amount reducing used only when the bit amount reducing is required, and the selection unit selecting the quantization matrix for bit amount reducing used for the current picture, when the bit amount reducing is required.

### BACKGROUND OF THE INVENTION

(1) Field of the Invention

The present invention relates to moving picture coding devices and broadcast wave recording devices which convert input moving pictures into coded signals representing information obtained by compressing data of moving pictures, and particularly relates to methods of coding quantization matrices.

(2) Description of the Related Art

General methods of coding moving pictures involve compressing the information amounts of the moving pictures by reducing redundancies in the temporal and spatial directions. A picture that is subjected to intra-picture prediction coding without reference to any reference picture is referred to as an I-picture (Intra-picture). The intra-picture prediction coding is performed with an aim to reduce redundancy in the spatial direction. In addition, a picture that is subjected to inter-picture prediction coding with reference to only a single reference picture is referred to as a P-picture (predictive picture). The inter-picture prediction coding is performed with an aim to reduce redundancy in the temporal direction. In addition, a picture that is subjected to inter-picture prediction coding with simultaneous reference to two pictures is referred to as a B-picture (Bi-predictive picture).

Such pictures in a general moving picture stream are managed in sets of at least one picture, and each of the sets is referred to as a GOP (Group Of Picture). Here, an exemplary GOP is a set of plural consecutive pictures starting with an I-picture and ending with a picture that is immediately before a next appearing I-picture. Another exemplary GOP is a set of consecutive pictures starting with a picture that can be used as a decoding-starting picture (random-access picture) in the case of starting decoding a target stream in the middle of the target stream.

Each of current pictures to be coded is segmented into units of coding that are blocks called macroblocks. Each of the blocks to be coded is subjected to either intra-prediction coding or inter-prediction coding. More specifically, this processing involves calculating a difference value between a prediction image generated by prediction in units of a macroblock and a current input image to be coded, performs orthogonal transform such as discrete cosine transform on the obtained difference image, and quantizing the transform coefficient values to compress the amount of information. At this time, it is possible to perform the quantization with different accuracies for the respective positions of frequency components, using a quantization matrix.

However, the degree of quantization accuracy that is appropriate for a frequency component in a position constantly changes because the moving picture has constantly changing image features. For example, the use of a quantization matrix that increases a quantization accuracy increases the data amount of a bit stream by the degree of the increase in the quantization accuracy. In contrast, the use of a quantization matrix that decreases a quantization accuracy deteriorates the image quality of a decoded stream by the degree of the decrease in the quantization accuracy. In particular, if the amount of bits becomes great, an estimated remaining capacity of a stream buffer becomes small. This may trigger control for coding the pictures into extremely small amount of data so as to prevent buffer overflow, resulting in a significant deterioration in the image quality.

One of the exemplary countermeasures against the aforementioned problem is disclosed by Patent Reference 1 (Japanese Unexamined Laid-open Patent Application Publication No. 10-150659). The method involves preparing plural quantization matrices in advance, selectively using the prepared quantization matrices depending on current occupied capacities of the buffer, and coding information indicating the used quantization matrices as header information of the respective picture. The use of this method makes it possible to reduce the amount of bits before the remaining capacity of a buffer becomes small and thus to reduce the risk of buffer overflow.

Another exemplary countermeasure is disclosed by Patent Reference 2 (Japanese Patent No. 4081727). The method involves calculating ratios between the actual amounts of bits generated when coding in units of a GOP is performed and target amounts of bits defined prior to the coding, selectively modifying the coefficient values of the quantization matrices depending on the ratios, and coding the selectively modified quantization matrices as header information. The use of this method makes it possible to reduce the amount of bits before the remaining capacity of a buffer becomes small, and thus to prevent buffer overflow. Furthermore, it is possible to reduce the risk of buffer overflow by increasing a quantization accuracy to enhance the image quality only when the actual amount of bits is smaller than the target amount of bits, that is, when a current picture is a simple picture that can be coded easily than expected.

On the other hand, one of the representative video coding standards is the H. 264 standard standardized by the ITU-T (International Telecommunication Union Telecommunication Standardization Sector) and the ISO (International Organization for Standardization). The H. 264 allows coding quantization matrices in form of header information at the beginning of each picture, or coding all the quantization matrices that are used for a current GOP at the beginning of the GOR The coding method conforming to the H. 264 standard only requires a one-time coding of quantization matrices even when they are repeatedly used for plural pictures in a GOR Therefore, it is possible to perform suppression so as to prevent unnecessary increase in the amounts of bits to be generated.

### SUMMARY OF THE INVENTION

However, according to the conventional techniques shown in Patent References 1 and 2 among the methods of coding quantization matrices all together at the beginning of a GOP as described above, information about a picture to be inputted in a currently being coded GOP is not known at the time header information is generated at the beginning of the current GOP. Therefore, there is a possibility of causing buffer overflow in the case where an extremely complicated picture is locally inputted in the middle of the current GOP.

The present invention has been conceived to solve the aforementioned problem, and has an object to provide a moving picture coding device and a broadcast wave recording device which enable coding without causing buffer overflow even in methods of coding quantization matrices all together at the beginning of control target groups such as GOPs.

In order to solve the above-described problem, a moving picture coding device according to the present invention codes a moving picture in units of a control target group including pictures, the moving picture coding device including: a quantization matrix generation unit configured to generate quantization matrices that are used in quantizing the pictures included in the control target group; a selection unit configured to select, from among the quantization matrices, a quantization matrix that is used in quantizing a current picture to be coded among the pictures; a coding unit configured to store the quantization matrices in a header part of the control target group, and code the current picture to be coded using the selected quantization matrix; a rate control unit which includes a virtual buffer, and is configured to perform, using the virtual buffer, buffer simulation based on an amount of bits to be outputted by the coding unit; and a determination unit configured to determine whether or not bit amount reducing is required for the current picture to be coded, based on a result of the buffer simulation performed by the rate control unit, wherein the quantization matrix generation unit is configured to generate, as the quantization matrices, a normal quantization matrix that is used in common for at least one of the pictures in the control target group, and a quantization matrix for bit amount reducing that is used only when the determination unit determines that the bit amount reducing is required, and the selection unit is configured to select the quantization matrix for bit amount reducing as the quantization matrix that is used in quantizing the current picture to be coded, when the determination unit determines that the bit amount reducing is required.

Furthermore, the present invention may be implemented as a broadcast wave recording device which codes, in units of a control target group including pictures, a moving picture broadcast by a broadcasting station, the broadcast wave recording device including: a quantization matrix generation unit configured to generate quantization matrices that are used in quantizing the pictures included in the control target group; a selection unit configured to select, from among the quantization matrices, a quantization matrix that is used in quantizing a current picture to be coded among the pictures; a coding unit configured to store the quantization matrices in a header part of the control target group, and code the current picture to be coded using the selected quantization matrix; a rate control unit which includes a virtual buffer, and is configured to perform, using the virtual buffer, buffer simulation based on an amount of bits to be outputted by the coding unit; and a determination unit configured to determine whether or not bit amount reducing is required for the current picture to be coded, based on a result of the buffer simulation performed by the rate control unit, wherein the quantization matrix generation unit is configured to generate, as the quantization matrices, a normal quantization matrix that is used in common for at least one of the pictures in the control target group, and a quantization matrix for bit amount reducing that is used only when the determination unit determines that the bit amount reducing is required, and the selection unit is configured to select the quantization matrix for bit amount reducing as the quantization matrix that is used in quantizing the current picture to be coded, when the determination unit determines that the bit amount reducing is required.

The present invention can be implemented not only as a moving picture coding device and a broadcast wave recording device like these, but also as a program product and an integrated circuit for executing the equivalent processes and processing as the processes and processing performed by the units included in the moving picture coding device.

The moving picture coding device in the present invention enables reducing the amount of bits to be generated, for example, even when a picture that is inputted and coded in the middle of a current control target group such as a GOP has an extremely complicated content, according to a method of coding quantization matrices all together at the beginning of the control target group. Therefore, the moving picture coding device is capable of generating a stream having a stable image quality without causing buffer overflow.

### FURTHER INFORMATION ABOUT TECHNICAL BACKGROUND TO THIS APPLICATION

The disclosure of Japanese Patent Application No. 2009-141818 filed on Jun. 15, 2009 including specification, drawings and claims is incorporated herein by reference in its entirety.

### BRIEF DESCRIPTION OF THE DRAWINGS

These and other objects, advantages and features of the invention will become apparent from the following description thereof taken in conjunction with the accompanying drawings that illustrate a specific embodiment of the invention. In the Drawings:

FIG. 1 is a block diagram showing an example of a structure of a moving picture coding device according to Embodiment 1 in the present invention;

FIG. 2 is a conceptual diagram showing an example of a structure of a bit stream in Embodiment 1;

FIG. 3 is a diagram showing an example of coefficient values of normal quantization matrices (normal QMs) and a quantization matrix for bit amount reducing (bit amount reducing QM) that are generated by a quantization matrix generation unit in Embodiment 1;

FIG. 4A is a flowchart indicating an example of a method of how the quantization matrix selection unit in Embodiment 1 selects one of the quantization matrices;

FIG. 4B is a flowchart indicating an example of a method of how the quantization matrix selection unit in Embodiment 1 selects one of the quantization matrices;

FIG. 5 is a diagram showing an example of transition of the amounts of bits accumulated in a buffer in Embodiment 1;

FIG. 6 is a flowchart indicating an example of another method of how the quantization matrix selection unit in Embodiment 1 selects one of the quantization matrices;

FIG. 7 is a block diagram showing an example of a structure of a moving picture coding device according to Embodiment 2 in the present invention;

FIG. 8A is a flowchart indicating an example of a method of how the quantization matrix generation unit in Embodiment 2 selects one of the quantization matrices;

FIG. 8B is a flowchart indicating an example of another method of how the quantization matrix generation unit in Embodiment 2 selects one of the quantization matrices;

FIG. 9 is a block diagram showing an example of a structure of a moving picture coding device according to Embodiment 3 in the present invention;

FIG. 10A is a flowchart indicating an example of a method of how the quantization matrix generation unit in Embodiment 3 selects one of the quantization matrices;

FIG. 10B is a diagram showing an example of relationships between the amounts of bits accumulated in a buffer and the coefficient values of a bit amount reducing QM in Embodiment 3; and

FIG. 11 is a conceptual diagram showing an example of an overall structure of a bit stream according to Embodiment 4 in the present invention.

### DESCRIPTION OF THE PREFERRED EMBODIMENTS

A moving picture coding device according to an embodiment of the present invention codes a moving picture in units of a control target group including pictures, the moving picture coding device including: a quantization matrix generation unit configured to generate quantization matrices that are used in quantizing the pictures included in the control target group; a selection unit configured to select, from among the quantization matrices, a quantization matrix that is used in quantizing a current picture to be coded among the pictures; a coding unit configured to store the quantization matrices in a header part of the control target group, and code the current picture to be coded using the selected quantization matrix; a rate control unit which includes a virtual buffer, and is configured to perform, using the virtual buffer, buffer simulation based on an amount of bits to be outputted by the coding unit; and a determination unit configured to determine whether or not bit amount reducing is required for the current picture to be coded, based on a result of the buffer simulation performed by the rate control unit, wherein the quantization matrix generation unit is configured to generate, as the quantization matrices, a normal quantization matrix that is used in common for at least one of the pictures in the control target group, and a quantization matrix for bit amount reducing that is used only when the determination unit determines that the bit amount reducing is required, and the selection unit is configured to select the quantization matrix for bit amount reducing as the quantization matrix that is used in quantizing the current picture to be coded, when the determination unit determines that the bit amount reducing is required.

The moving picture coding device configured as described above enables reducing the amount of bits to be generated, for example, even when a picture that is inputted and coded in the middle of a current control target group such as a GOP has extremely complicated content, in the middle of a current control target group that is a control target structural unit such as a GOP and a moving picture to be inputted, according to a method of coding quantization matrices all together at the beginning of the control target group. Therefore, the moving picture coding device is capable of generating a stream having a stable image quality without causing buffer overflow. Here, a control target group is a control target unit of processing that is handled in the processing started when a video signal is inputted and finished when the video signal is outputted in form of a coded signal. More specifically, a control target group becomes the whole or a part of a video signal to be inputted. A structure using GOPs or the like that are control target units of coding is possible as a control target group in the case of using a part of a video signal. In the case of using GOPs as control target units, a single or plural number of GOPs may be used.

The aforementioned reducing is not normal control performed in the coding unit, but processing that is performed in the case where the amount of bits to be generated in a particular picture within a control target group increases, and either the amount of bits for coding the whole control target group or the amount of bits of the particular picture exceeds or is likely to exceed the bit amount defined in a coding standard. The normal control here is control for achieving an object of decreasing the amount of bits required to code a target input moving picture to be coded.

The coding unit is configured to perform normal control using plural normal quantization matrices that are set in common for one or more pictures within a control target group, and to perform reducing using a quantization matrix for bit amount reducing in the case where the amount of bits to be generated in a particular picture within a control target group increases, and either the amount of bits for coding the whole control target group or the amount of bits of the particular picture exceeds or is likely to exceed the bit amount defined in a coding standard.

Furthermore, the determination unit may be configured to determine that the bit amount reducing is required, when an amount of bits accumulated in the virtual buffer is equal to or greater than a predetermined threshold value.

In this way, in the case where the amount of bits accumulated in the buffer exceeds the threshold value, that is, the possibility of buffer overflow increases, it is possible to further reduce the possibility of buffer overflow using the quantization matrix for bit amount reducing that has a bit amount reducing effect higher than the effect that can be provided when using the normal quantization matrices.

Furthermore, the rate control unit may be further configured to generate quantization values that are used in quantizing the current picture to be coded, based on the result of the buffer simulation, and the determination unit is configured to determine that the bit amount reducing is required, when each of the quantization values is equal to or greater than a predetermined threshold value.

In this way, it is possible to further reduce the possibility of buffer overflow using the quantization matrix for bit amount reducing when only control of quantization values does not provide a sufficient bit amount reducing effect.

Furthermore, the rate control unit may be further configured to set, for each of the pictures, a target amount of bits that should be achieved, and the determination unit is configured to determine that the bit amount reducing is required, when the quantization values are maximum values within a controllable range and when an amount of bits generated by coding at least one of pictures preceding the current picture to be coded is greater than the target amount of bits.

In this way, it is possible to further reduce the possibility of buffer overflow using the quantization matrix for bit amount reducing when only control of quantization values does not prevent buffer overflow.

Furthermore, the quantization matrix generation unit may be further configured to determine whether or not to generate the quantization matrix for bit amount reducing, based on the amount of bits to be outputted by the coding unit, and generate the quantization matrix for bit amount reducing when the quantization matrix for bit amount reducing is determined to be generated.

In this way, a determination is made as to whether or not to generate a quantization matrix for bit amount reducing, to put it differently, whether or not to store the quantization matrix for bit amount reducing in the header part of the control target group. This makes it possible to eliminate the necessity of storing a quantization matrix for bit amount reducing when the possibility of buffer overflow is low, and thus any quantization matrix for bit amount reducing is unlikely to be used for a current control target group. Therefore, it is possible to increase the coding efficiency.

Furthermore, the quantization matrix generation unit may be configured to generate the quantization matrix for bit amount reducing when a bit rate of bits outputted by the coding unit is equal to or smaller than a predetermined threshold value.

In this way, in the case where an output bit rate is equal to or smaller than a threshold value, coding must be performed using a low bit rate, creating a situation where the amount of bits accumulated in a buffer is likely to increase in a short time, thereby increasing the possibility of buffer overflow. In this case, it is possible to reduce the possibility of buffer overflow by generating and storing a quantization matrix for bit amount reducing.

Furthermore, the quantization matrix generation unit may be configured to generate the quantization matrix for bit amount reducing when the amount of bits accumulated in the virtual buffer is equal to or greater than a predetermined threshold.

In this way, in the case where the amount of bits accumulated in a buffer exceeds a threshold value, to put it differently, the possibility of buffer overflow increases, it is possible to reduce the possibility of buffer overflow by generating and storing a quantization matrix for bit amount reducing.

Furthermore, the quantization matrix generation unit may be configured to generate, for the respective control target groups, a quantization matrices for bit amount reducing each having a set of coefficient values that is determined according to an amount of bits accumulated in the virtual buffer and is different from a set of coefficient values of any other one of the quantization matrices for bit amount reducing.

In this way, the coefficients of the quantization matrices for bit amount reducing are changed depending on the amounts of bits accumulated in the buffer. Thus, for example, when there is sufficient space in the buffer, it is possible to minimize deterioration in the image quality using quantization matrices for bit amount reducing having small coefficient values. In addition, for example, when there is no sufficient space in the buffer, it is possible to further reduce the possibility of buffer overflow using quantization matrices for bit amount reducing having large coefficient values.

Furthermore, the quantization matrix generation unit may be configured to generate the quantization matrices for bit amount reducing such that the sets of coefficient values become larger as the amounts of bits accumulated in the virtual buffer become greater.

In this way, it is possible to reduce the possibility of buffer overflow.

Furthermore, the quantization matrix generation unit may be configured to generate the quantization matrices for bit amount reducing such that the sets of coefficient values become smaller as the amounts of bits accumulated in the virtual buffer become smaller.

In this way, it is possible to minimize deterioration in the image quality.

Furthermore, the quantization matrix generation unit may be configured to generate the quantization matrix for bit amount reducing such that coefficient values for low frequency components in the quantization matrix for bit amount reducing are twice or more of coefficient values for low frequency components in the normal quantization matrix.

In this way, it is possible to reduce the amount of bits especially for the low frequency components with large data amounts, and thus to effectively reduce the amounts of bits.

### Embodiment 1

Embodiment 1 according to the present invention will be described below with reference to the drawings.

A moving picture coding device according to Embodiment 1 in the present invention includes: a quantization matrix generation unit which generates (i) normal quantization matrices each of which is used in a quantization process according to normal rate control and (ii) a quantization matrix for bit amount reducing which is used when strong bit amount reducing is determined to be required compared to the case of performing the quantization process according to the normal rate control, more specifically, strong bit amount reducing is required which reduces the amount of bits to be generated in the quantization process according to such reducing more effectively than the amount of bits to be generated in the quantization process according to normal rate control; and a coding unit which stores the normal quantization matrices and the quantization matrix for bit amount reducing in the header part of a current control target group including plural pictures, and codes the current pictures to be coded, selectively using the normal quantization matrices and the quantization matrix for bit amount reducing. In addition, the moving picture coding device in Embodiment 1 includes a determination unit which determines whether or not bit amount reducing is required, and a selection unit which selects a quantization matrix for bit amount reducing when reducing is determined to be required.

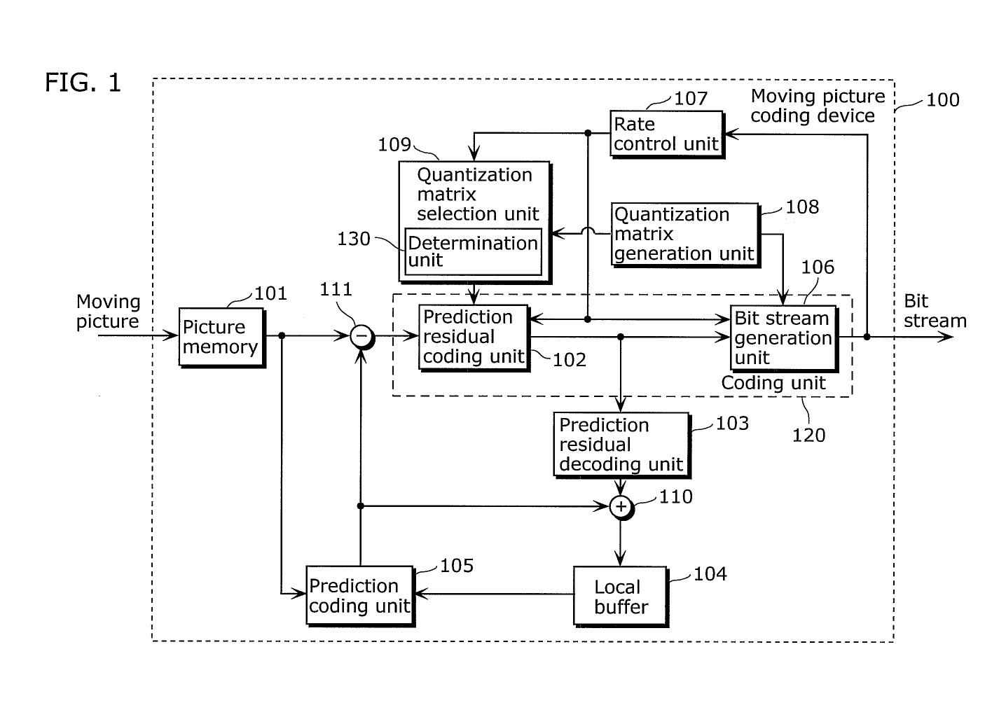

First, a structure of a moving picture coding device according to Embodiment 1 in the present invention is described with reference to FIG. 1.

FIG. 1 is a block diagram showing an exemplary structure of the moving picture coding device 100 in Embodiment 1. As shown in FIG. 1, the moving picture coding device 100 includes: a picture memory 101; a prediction residual coding unit 102; a prediction residual decoding unit 103; a local buffer 104; a prediction coding unit 105; a bit stream generation unit 106; a rate control unit 107; a quantization matrix generation unit 108; a quantization matrix selection unit 109; an addition operation unit 110; and a difference operation unit 111. Here, the prediction residual coding unit 102 and the bit stream generation unit 106 constitute a coding unit 120. In addition, the quantization matrix selection unit 109 includes a determination unit 130.

The picture memory 101 stores each of the pictures in a moving picture that is inputted in display order such that the pictures are rearranged in coding order. When the picture memory 101 receives an input of a read instruction from the difference operation unit 111 and the prediction coding unit 105, it outputs the moving picture specified by the read instruction in form of an input image signal. Here, for example, each of the pictures is segmented into macroblocks each composed of 16 horizontal pixels×16 vertical pixels, based on which the subsequent processing is performed.

The prediction residual coding unit 102 performs orthogonal transform on a difference image signal that is outputted from the difference operation unit 111. Further, the prediction residual coding unit 102 generates a coded residual signal by quantizing the orthogonally transformed difference image signal using quantization matrix (QM) that is selected by the quantization matrix selection unit 109 and quantization parameters (QPs) that are outputted by the rate control unit 107.

Subsequently, the prediction residual coding unit 102 outputs the generated coded residual signal to the prediction residual decoding unit 103 and the bit stream generation unit 106. Here, the orthogonal transform coefficients of the respective frequency components resulting from orthogonal transform are quantized using QP values that are set for each of the macroblocks in a picture and coefficient values located at the corresponding frequency component positions in a QM that is selected for the picture.

The prediction residual decoding unit 103 generates a decoded residual signal by performing inverse quantization and inverse orthogonal transform on the coded residual signal that is outputted by the prediction residual coding unit 102. Subsequently, the prediction residual decoding unit 103 outputs the resulting decoded residual signal to the addition operation unit 110.

The local buffer 104 stores a signal that may be referred to in inter-picture prediction coding of the macroblocks subsequent to a current macroblock to be coded, among the signals that are outputted by the addition operation unit 110.

The prediction coding unit 105 generates a prediction image signal using intra-picture prediction or inter-picture prediction, based on an input image signal that is outputted from the picture memory 101. Subsequently, the prediction coding unit 105 outputs the generated prediction image signal to the difference operation unit 111 and the addition operation unit 110. Here, it is assumed that a signal to be stored in a local buffer 104 is used in inter-picture prediction.

The bit stream generation unit 106 outputs a bit stream by performing variable length coding on (i) the difference image signal that is outputted by the prediction residual coding unit 102, and (ii) coding information indicating the QMs that are outputted by the quantization matrix generation unit 108, and the amounts of bits accumulated in a buffer and QP values both of which are outputted by the rate control unit 107. A detailed structure of a bit stream is described later.

As described above, the prediction residual coding unit 102 and the bit stream generation unit 106 constitute a coding unit 120. More specifically, since the coding unit 120 includes the prediction residual coding unit 102 and the bit stream generation unit 106, the coding unit 120 stores the plural quantization matrices generated by the quantization matrix generation unit 108 in the header part of a control target group, and codes a current picture to be coded using the quantized matrices selected by the quantization matrix selection unit 109. Here, the current picture to be coded is one of the pictures that constitute a control target group. More specifically, the coding unit 120 codes each of the plural pictures using a quantization matrix selected for the picture, from among the plural quantization matrices stored all together in the header part of the control target group.

The rate control unit 107 includes a virtual buffer, and performs buffer simulation based on the amount of bits to be outputted by the coding unit 120, using the virtual buffer. The buffer simulation is processing of simulating the amounts of bits accumulated in the virtual buffer in the case where a bit stream outputted by the coding unit 120 is accumulated in the virtual buffer and the bit stream is read out from the virtual buffer.

Subsequently, the rate control unit 107 performs control based on the result of the buffer simulation. The rate control is processing for adjusting the amounts of bits for the bit stream to be outputted by the coding unit 120. For example, the rate control unit 107 determines and generates quantization values (QP values) based on the amounts of bits accumulated in the buffer. More specifically, the rate control unit 107 increases the quantization values when the amount of bits accumulated in the buffer increases, and decreases the quantization values when the amount of bits accumulated in the buffer decreases.

More specifically, the rate control unit 107 observes the bit stream to be outputted by the bit stream generation unit 106, and generates the amount of bits accumulated in the buffer which indicates the amount of bits for the bit stream and the QP values to be used by the prediction residual coding unit 102. The amount of bits accumulated in the buffer and QP values are outputted to the bit stream generation unit 106 and the quantization matrix selection unit 109. The QP values are outputted also to the prediction residual coding unit 102.

The quantization matrix generation unit 108 generates plural quantization matrices to be used when quantizing the plural pictures that constitute the control target group. More specifically, the quantization matrix generation unit 108 generates, as plural quantization matrices, (i) normal quantization matrices (hereinafter also referred to as normal QMs) to be used in common for one or more of the pictures that constitute the control target group and (ii) a quantization matrix for bit amount reducing (hereinafter also referred to as a bit amount reducing QM) to be used only when the determination unit 130 determines that strong bit amount reducing is required which reduces the amount of bits to be generated in quantization processing according to such reducing more effectively than the amount of bits to be generated in quantization processing according to normal rate control.

The normal quantization matrices are used in quantization according to normal rate control. Meanwhile, the quantization matrix for bit amount reducing is used when significant bit amount reducing is required compared to the case of performing quantization according to the normal rate control. More specifically, the quantization matrix for bit amount reducing is used when significant bit amount reducing is determined to be required compared to the case of performing quantization according to the normal rate control. The control target group is, for example, a GOP.

More specifically, when starting processing on a GOP, the quantization matrix generation unit 108 generates all together the following: (i) normal QMs to be used for the pictures of the GOP; and (ii) a bit amount reducing QM to be used only for the purpose of reducing the amount of bits for a bit stream to be outputted by the bit stream generation unit 106. The resulting normal QMs and bit amount reducing QM are outputted to the bit stream generation unit 106 and the quantization matrix selection unit 109. How to generate the normal QMs and bit amount reducing QM is described later.

The quantization matrix selection unit 109 selects a quantization matrix to be used when quantizing a current picture to be coded from among the plural quantization matrices generated by the quantization matrix generation unit 108. The quantization matrix selection unit 109 selects the quantization matrix to be used in quantization for each picture. As shown in FIG. 1, the quantization matrix selection unit 109 includes a determination unit 130.

More specifically, the quantization matrix selection unit 109 selects a bit amount reducing QM as the quantization matrix to be used in quantizing a current picture to be coded when the determination unit 130 determines that significant bit amount reduction is required. More specifically, the quantization matrix selection unit 109 selects a normal control QM as the quantization matrix to be used in quantizing a current picture to be coded when the determination unit 130 determines that significant bit amount reducing is not required.

More specifically, the quantization matrix selection unit 109 selects one of the QMs from among the plural QMs generated by the quantization matrix generation unit 108, based on the amount of bits accumulated in the buffer and QP values generated by the rate control unit 107, and outputs the selected one of the QMs to the prediction residual coding unit 102. How to select one of the plural QMs generated by the quantization matrix generation unit 108 is described later.

The determination unit 130 determines whether or not bit amount reducing is required for the current picture to be coded, based on the result of the buffer simulation performed by the rate control unit 107. More specifically, the determination unit 130 determines whether or not bit amount reducing is required, based on information that is used or generated by the rage control unit 107.

Here, the bit amount reducing is for reducing a greater amount of bits in the case where quantization according to normal rate control is insufficient to reduce the amount of bits. More specifically, the bit amount reducing is quantization using not the normal QM but the bit amount reducing QM with coefficient values greater than those in the normal QM.

For example, the determination unit 130 determines that bit amount reducing is required for the current picture to be coded when the amount of bits accumulated in the virtual buffer is equal to or greater than the predetermined threshold. Furthermore, the determination unit 130 determines that bit amount reducing is required for the current picture to be coded when the QP values that are quantization values are equal to or greater than the predetermined threshold.

Here, it is also good to dynamically change the threshold value to be used for determining the amounts of accumulated bits and the threshold value to be used for determining the QP values. For example, the threshold values are determined so as to prevent the virtual buffer used in buffer simulation from overflowing.

The addition operation unit 110 generates a reconstructed image signal by adding the decoded residual signal that is outputted by the prediction residual decoding unit 103 and the prediction image signal that is outputted by the prediction coding unit 105. Furthermore, the addition operation unit 110 outputs the generated reconstructed image signal to the local buffer 104.

The difference operation unit 111 generates a difference image signal by calculating the difference between the input image signal read out from the picture memory 101 and the prediction image signal that is output by the prediction coding unit 105. Subsequently, the difference operation unit 111 outputs the generated difference image signal to the prediction residual coding unit 102.

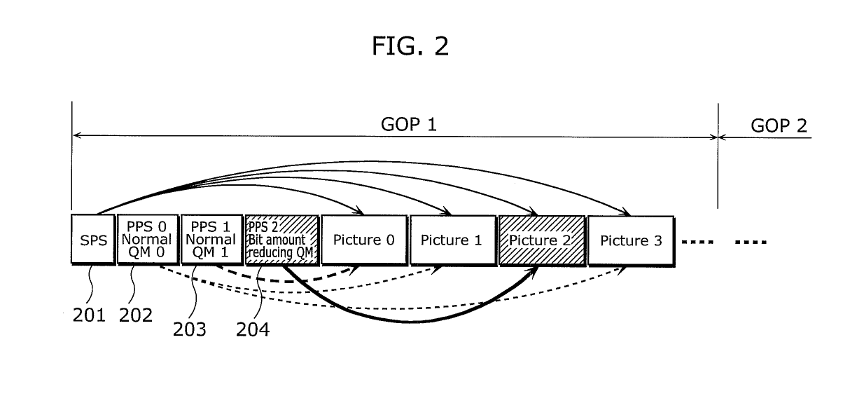

Here, a structure of a bit stream that is generated by the bit stream generation unit 106 is described with reference to FIG. 2.

FIG. 2 is a conceptual diagram showing an exemplary structure of a bit stream in Embodiment 1. As shown in FIG. 2, a bit stream in Embodiment 1 is an input moving picture composed of structural units that are GOPs each including plural pictures.

As for plural pictures included in each GOP, for example, parameters used in common in decoding or the like are coded in a header area (SPS 201 in FIG. 2) called SPS (Sequence Parameter Set). In addition, the parameters having values selectively used for the respective pictures are written in header areas (PPSs 202, 203, and 204) called PPSs (Picture Parameter Sets).

As shown in FIG. 2, the bit stream generation unit 106 in Embodiment 1 stores the plural PPSs all together in the header parts located at the beginning of the respective control target groups, and each of the plural PPSs stores a different quantization matrix

In FIG. 2, one SPS 201 is used for reference for all the pictures in a GOP 1, and the PPSs 202, 203, and 204 are selectively used for the individual pictures. For example, PPS 0 (PPS 202) is used for Picture 1 and Picture 3, and PPS 1 (PPS 203) is used for Picture 0, and PPS 2 (PPS 204) is used for Picture 2. In this way, collectively coding all the PPSs required for the GOP in the header reduces the number of PPSs required to form a stream compared to the case of coding a single PPS for each picture. This makes it possible to perform suppression so as to prevent unnecessary increase in the amount of bits to be generated. Here, either the normal QMs or the bit amount reducing QM generated by the quantization matrix generation unit 108 is stored as a parameter in each of the PPSs 202, 203, and 204.

The QM required in quantizing a picture is stored in a PPS. In the example of FIG. 2, normal QM 0 and QM 1 generated using a general quantization matrix generation method are stored in PPS 0 and PPS 1, respectively. Furthermore, a bit amount reducing QM for reducing the amount of bits for the bit stream is coded in PPS 2. This makes it possible to select the QM to be used for the current picture by selecting the PPS to be used. Here, information indicating the selected PPS is included in the coded data of the picture (such as Picture 0 in FIG. 2).

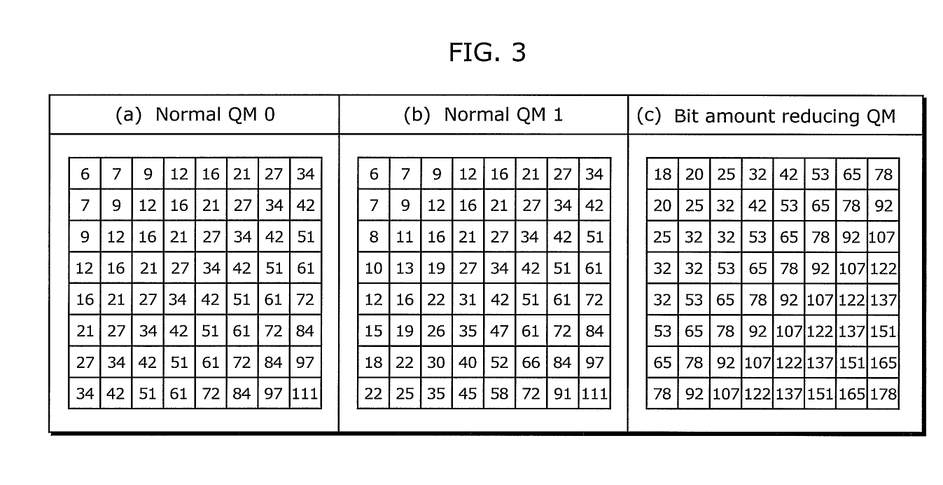

Next, the normal QMs and bit amount reducing QM generated by the quantization matrix generation unit 108 are described in detail with reference to FIG. 3.

FIG. 3 is a diagram showing an example of coefficient values of normal QMs and a bit amount reducing QM both of which are generated by the quantization matrix generation unit 108.

In the normal QM 0 shown in (a) of FIG. 3, the coefficient value at the position of the lowest frequency component is 6, and the coefficient value at the position of the highest frequency component is 111. Here, quantization can be performed using a finer quantization step as the respective coefficient values of the QM are smaller. In other words, lower frequency components are coded such that the information can be reproduced more accurately.

However, larger amounts of bits are required in coding as the coefficient values of a quantization matrix become smaller. Therefore, it is necessary to control the magnitudes of these values depending on the priority between image quality and compression rate. In the normal QM 1 shown in (b) of FIG. 3, small values are set for the coefficient values of the components located at lower left positions, compared to those in the normal QM 0. This setting is for performing high-accuracy quantization on vertical components even in the high frequency component area, and therefore is suitable for, for example, coding an interlace picture having pixel values that significantly vary in the vertical direction.

In contrast, in the bit amount reducing QM shown in (c) of FIG. 3, large coefficient values are set for all the components located from the low frequency area to the high frequency area, compared to those in the other QMs (the normal QM 0 and QM 1). In other words, the bit amount reducing QM is, for example, a quantization matrix having coefficient values all of which are greater than the corresponding coefficient values of the other quantization matrices (normal QMs) used for the same control target group. Accordingly, the use of this QM provides an advantageous effect of reducing the amounts of bits to be generated in all the low and high frequency areas, with deterioration in the resulting image quality.

In most cases, coefficient values resulting from orthogonal transform are large dominantly in the low frequency area. In other words, the bit amount reducing becomes more effective as the coefficient values in the low frequency area in the QM become large.

Accordingly, in order to achieve a significant reducing effect, the quantization matrix generation unit 108 may generate, for example, a bit amount reducing QM as shown in (c) of FIG. 3 such that the coefficient values of the low frequency components in the bit amount reducing QM are twice or more of the coefficient values of the low frequency components in the normal QMs. The low frequency components are in the area including the coefficient value located at the left top end position in the quantization matrix, and for example, are in the left top half of the quantization matrix. In the example of FIG. 3, the coefficient values of the low frequency component area in the bit amount reducing QM provide a significant bit amount reducing effect because the coefficient values are twice or more of the corresponding coefficient values of the other QMs.

In Embodiment 1, at least one such bit amount reducing QM is coded in at least one PPS disposed at the header of each GOP. In other words, the moving picture coding device 100 in Embodiment 1 stores at least one bit amount reducing QM at the header part of each control target group, in addition to at least one normal QM.

In the case where no bit amount reducing processing is required for, for example, a current I-picture to be coded, the quantization matrix selection unit 109 selects the normal QM 0 shown in (a) of FIG. 3. Likewise, in the case where no bit amount reducing processing is required for a current picture to be coded that is either a P-picture or a B-picture, the quantization matrix selection unit 109 selects the normal QM 1 shown in (b) of FIG. 3.

The normal QMs are generated according to a general method of generating quantization matrices. For example, the normal QMs are quantization matrices that are determined based on the details (such as flatness and degrees of motions) of a moving picture to be inputted under control for preventing deterioration in the image quality. In addition, the bit amount reducing QM may be any coded matrix having coefficient values larger than those in the normal QMs, and thus any methods of generating such coefficient values are possible.

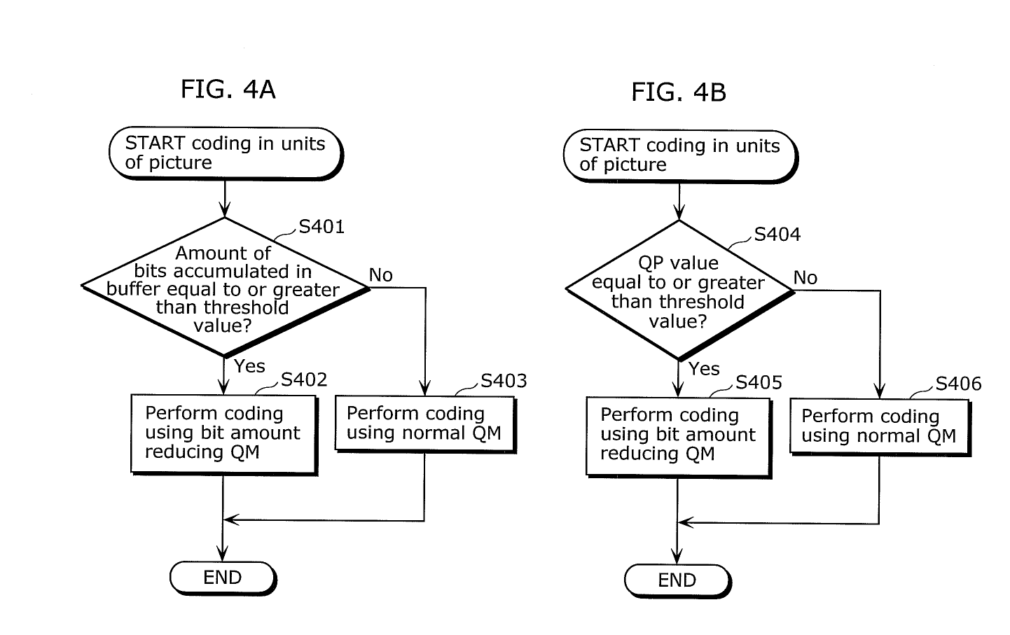

Next, a quantization matrix selection method performed by the quantization matrix selection unit 109 is described in detail with reference to FIGS. 4A and 4B.

FIG. 4A is a flowchart of selecting, based on the amounts of bits accumulated in the buffer, one of quantization matrices generated by the rate control unit 107. The rate control unit 107 shown in FIG. 1 calculates the amounts of bits accumulated in the buffer, based on the amount of bits of data outputted in form of already coded pictures.

First, the determination unit 130 determines whether or not the amount of bits accumulated in the buffer is equal to or greater than the preset threshold value (S401). In the case where the amount of bits accumulated in the buffer is equal to or greater than the threshold value (Yes in S401), the determination unit 130 determines that there is a risk of buffer overflow unless the bit amount is reduced, to put it differently, the determination unit 130 determines that bit amount reducing is required. Thus, the quantization matrix selection unit 109 selects the bit amount reducing QM so that quantization is performed using the selected bit amount reducing QM (S402).

In the case where the amount of bits accumulated in the buffer is smaller than the threshold value (No in S401), the determination unit 130 determines that no bit amount reducing is required. Thus, the quantization matrix selection unit 109 selects a normal QM so that quantization is performed using the selected normal QM (S403). As shown in FIG. 3, in an exemplary case where plural normal QMs are prepared, the quantization matrix selection unit 109 selects one of the normal QMs according to normal rate control.

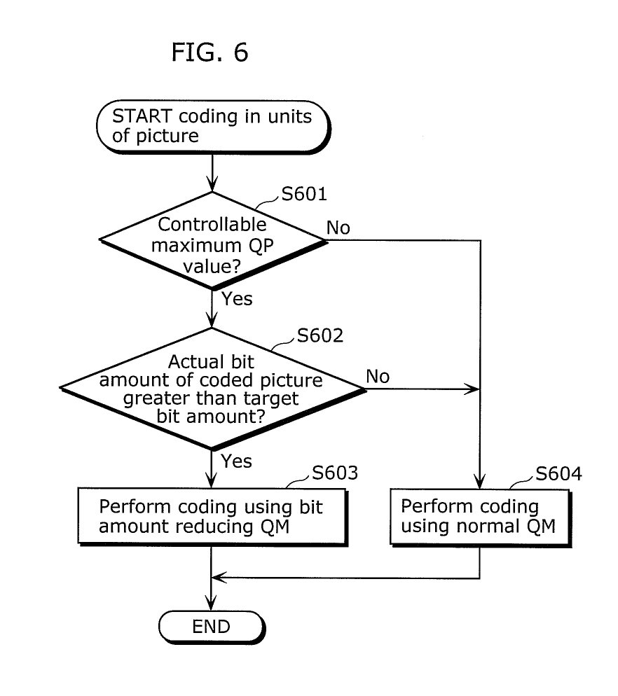

The above-described processing is executed at the time of starting coding the current picture to be coded. The above-described processing executed at the time of starting coding the current picture to be coded is the same in FIG. 4B and FIG. 6.

As described above, the quantization matrix selection unit 109 selects either the normal QMs or the bit amount reducing QM, based on the amount of bits accumulated in the buffer. As shown in FIG. 4B, the quantization matrix selection unit 109 may select either the normal QMs or the bit amount reducing QM, based on the quantization values (QP values) instead of the amount of bits accumulated in the buffer.

FIG. 4B is a flowchart of selecting, based on the QP values, one of quantization matrices generated by the rate control unit 107. Here, it is assumed that the rate control unit 107 calculates the QP values, based on information such as the amounts of bits of data and QP values outputted in form of the already coded pictures.

First, the determination unit 130 determines whether or not the QP values are equal to or greater than the predetermined threshold value (S404). In the case where the QP values is equal to or greater than the threshold value (Yes in S404), the determination unit 130 determines that coding must be performed using large QP values according to rate control, to put it differently, determines that the amount of bits to be generated must be reduced. Thus, the quantization matrix selection unit 109 selects the bit amount reducing QM so that quantization is performed using the selected bit amount reducing QM (S405).

In the case where the QP values are smaller than the threshold value (No in S404), the determination unit 130 determines that coding can be performed using small QP values according to rate control, to put it differently, determines that no bit amount reducing is required. Thus, the quantization matrix selection unit 109 selects a normal QM so that quantization is performed using the selected normal QM (S406).

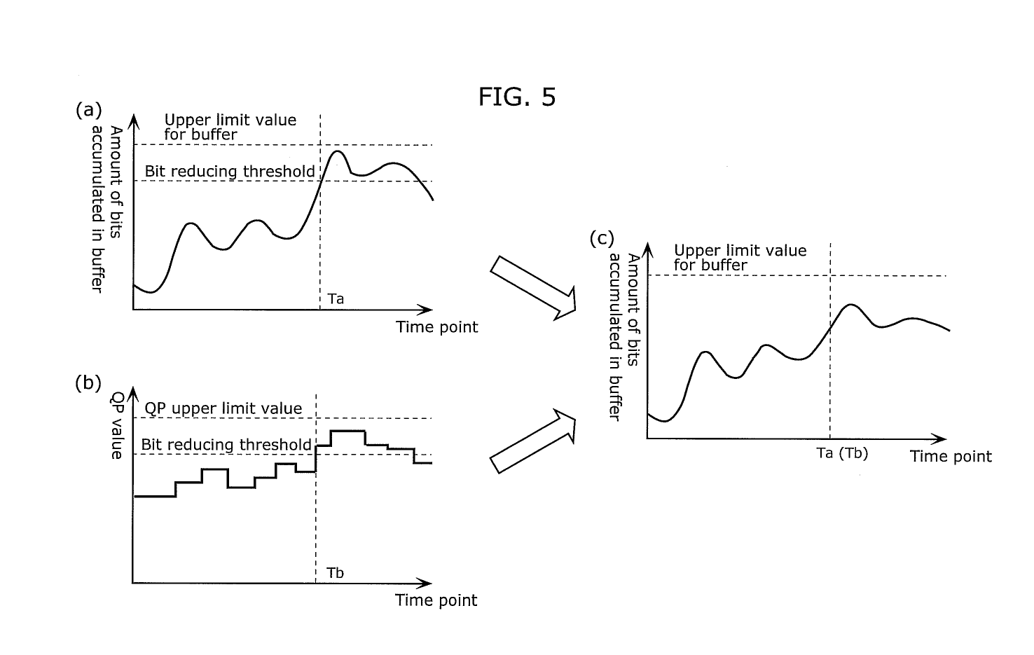

Furthermore, the selection operation performed by the quantization matrix selection unit 109 is described in detail with reference to FIG. 5. FIG. 5 is a diagram showing an example of transition of the amounts of bits accumulated in the buffer in the case where control is performed based on either the amounts of bits accumulated in the buffer or the QP values.

Here, (a) of FIG. 5 shows transition of the amounts of bits accumulated in the buffer. The horizontal axis represents time points, and the vertical axis represents the amounts of bits accumulated in the buffer at the respective time points. In the example of the above diagram, a complicated picture suddenly appears and is coded at the time point Ta, which causes the amount of accumulated bits to exceed the threshold value for bit reducing. For this, the buffer does not have sufficient space, and thus there is a risk that the upper limit for the buffer is exceeded.

In Embodiment 1, pictures in the period after the time point Ta at which the threshold value is exceeded are coded using a bit amount reducing QM, and thus it is possible to transit the current amount of accumulated bits to the amount of accumulated bits that provides sufficient space in the buffer as shown in (c) of FIG. 5. Accordingly, even when a complicated picture is inputted locally in the middle of a GOP, it is possible to prevent a risk of buffer overflow.

Here, during the period in which the amounts of bits accumulated in the buffer exceed the threshold value, the quantization matrix selection unit 109 selects the bit amount reducing QM. In the case where the amount of bits accumulated in the buffer falls within the threshold value, the quantization matrix selection unit 109 selects a normal QM.

In addition, (b) of FIG. 5 shows transition of QP values. The horizontal axis represents time points, and the vertical axis represents QP values at the respective time points. The QP values become larger with an increase in the necessity for reducing the bit amounts according to rate control. Thus, in the diagram, the QP values are large in the period after the time point Tb at which a complicated picture suddenly appears and is coded, during which the buffer space is insufficient.

In Embodiment 1, pictures in the period after the time point Tb at which the threshold value exceeds are coded using a bit amount reducing QM, and thus it is possible to transit the current amount of accumulated bits to the amount of accumulated bits that can provide sufficient space in the buffer as shown in (c) of FIG. 5. Accordingly, even when a complicated picture is inputted locally in the middle of a GOP, it is possible to prevent a risk of buffer overflow.

Here, during the period in which the QP values exceed the threshold value, the quantization matrix selection unit 109 selects the bit amount reducing QM. In the case where the QP values fall within the threshold value, the quantization matrix selection unit 109 selects a normal QM.

In addition, it is possible to set the QP values in units of a picture, a slice, or a macroblock. Here, (b) of FIG. 5 shows an example of setting QP values in units of plural pictures.

Next, another implementation of a QM selection method performed by the quantization matrix selection unit 109 is described with reference to FIG. 6. FIG. 6 is a flowchart showing an example of another method of how the quantization matrix selection unit 109 in Embodiment 1 selects one of the quantization matrices.

First, the determination unit 130 determines whether or not the QP values calculated by the rate control unit 107 are the maximum values controllable as QP values (S601). In the case where the QP values are the maximum values defined according to the coding standard (Yes in S601), the determination unit 130 further determines whether or not the actual amount of bits generated in coding the already coded pictures and calculated by the rate control unit 107 is greater than the target amount of bits for the already coded pictures (S602).

In the case where the determination unit 130 determines the actual amount of bits is greater than the target amount of bits (Yes in S602), it determines that there is a high risk of buffer overflow because the amounts of generated bits keep exceeding the target value under the situation where control by QP values is not sufficient to reduce the amounts of bits. Thus, the quantization matrix selection unit 109 selects the bit amount reducing QM so that quantization is performed using the selected bit amount reducing QM (S603).

In the case where the QP values are not the maximum values (No in S601), or in the case where the actual amount of generated bits is equal to or smaller than the target amount of bits (No in S602), the determination unit 130 determines that even the use of QP values of a normal QM enables bit amount reducing or determines that there is no possibility that the amounts of bits accumulated in the buffer keep increasing. Thus, the quantization matrix selection unit 109 selects the normal QM so that quantization processing is performed using the selected normal QM (S604).

According to this method, the bit amount reducing QM is used only in the situation where control by QP values is not sufficient to reduce the amounts of bits accumulated in the buffer and the amounts of bits are on the increase. Therefore, it is possible to minimize the usage range of the bit amount reducing QM. Accordingly, it is possible to minimize the number of pictures whose quality is deteriorated if the bit amount reducing QM is used.

Here, it is possible to perform control, selectively using one of the respective processes described with reference to FIGS. 4A, 4B, and 6, or using a combination of arbitrarily selected two or more of the processes.

As described above, in Embodiment 1, it is possible to perform efficient coding by storing a bit amount reducing QM for reducing the amounts of bits to be generated in the header part of each GOP when performing quantization as a process of coding a moving picture to be inputted into the moving picture coding device 100, and applying, in the quantization, the bit amount reducing QM according to the control for the amounts of bits to be generated.

In other words, the moving picture coding device 100 in Embodiment 1 generates two kinds of quantization matrices that are a normal quantization matrix and a quantization matrix for bit amount reducing as candidate quantization matrices that are selectively used for pictures in each control target group to be coded, and stores the two kinds of quantization matrices in the header part of the control target group all together. In this way, it is possible to perform quantization using the quantization matrix for stronger bit amount reducing when a buffer is likely to overflow if quantization using a normal quantization matrix is performed.

Accordingly, the moving picture coding device 100 in Embodiment 1 is capable of not only increasing coding efficiency by storing quantization matrices all together in the header part of a current control target group, but also reducing the amounts of bits to be generated so as to prevent a buffer from overflowing even when a complicated picture is included in the middle of the current control target group.

### Embodiment 2

In Embodiment 1, it is assumed that the QMs generated by the quantization matrix generation unit 108 are the normal QMs and the bit amount reducing QM which are predefined and directly coded. However, the bit amount reducing QM may be generated even if it is not required in quantizing a picture within a GOP, and thus produces a problem of disabling efficient use of the header of the GOP.

For this, in Embodiment 2, a quantization matrix generation unit determines whether or not to generate a bit amount reducing QM using a result of buffer simulation, and generates the bit amount reducing QM with a determination that the bit amount reducing QM should be generated.

Next, a moving picture coding device according to Embodiment 2 is described with reference to the drawings.

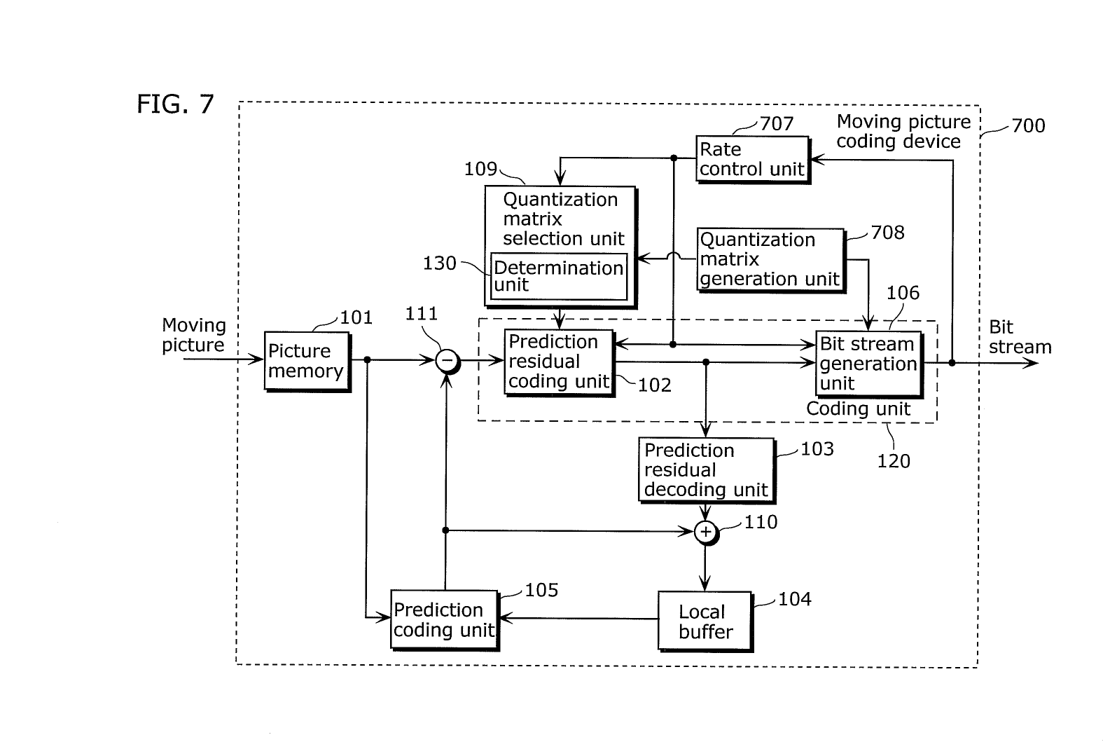

FIG. 7 is a block diagram showing an exemplary structure of the moving picture coding device 700 in Embodiment 2.

The moving picture coding device 700 shown in FIG. 7 differs from the moving picture coding device 100 shown in FIG. 1 in the point of including a rate control unit 707 instead of the rate control unit 107, and including a quantization matrix generation unit 708 instead of the quantization matrix generation unit 108. In other words, the moving picture coding device 700 in Embodiment 2 differs from the moving picture coding device 100 in Embodiment 1 in the point of using output by the rate control unit 707 as input into the quantization matrix generation unit 708.

The same structural elements as those in Embodiment 1 are assigned with the same reference numerals, and descriptions therefor are omitted. The following description is focused on the differences.

The rate control unit 707 functions in the same manner as the rate control unit 107 in Embodiment 1, and further outputs the amounts of bits accumulated in a buffer and QP values to the quantization matrix generation unit 708.

The quantization matrix generation unit 708 determines whether or not to generate a bit amount reducing QM, based on the amount of bits to be outputted by the coding unit 120, that is, the amount of bits for a bit stream to be outputted by the coding unit 120. For example, the quantization matrix generation unit 708 generates a bit amount reducing QM in the case where the output bit rate for the bit stream to be outputted by the coding unit 120 is equal to or smaller than a predetermined threshold value.

Otherwise, the quantization matrix generation unit 708 determines whether or not to generate a bit amount reducing QM, based on the result of the buffer simulation that the rate control unit 707 executes using the amount of bits for the bit stream outputted by the coding unit 120. More specifically, the quantization matrix generation unit 708 generates a bit amount reducing QM in the case where the amount of bits accumulated in a virtual buffer is equal to or greater than the predetermined threshold value.

In other words, the quantization matrix generation unit 708 determines whether or not to generate a bit amount reducing QM, based on information generated by the rate control unit 707. The other operations by the quantization matrix generation unit 708 are the same as those performed by the quantization matrix generation unit 108 in Embodiment 1, and thus the same descriptions are not repeated here.

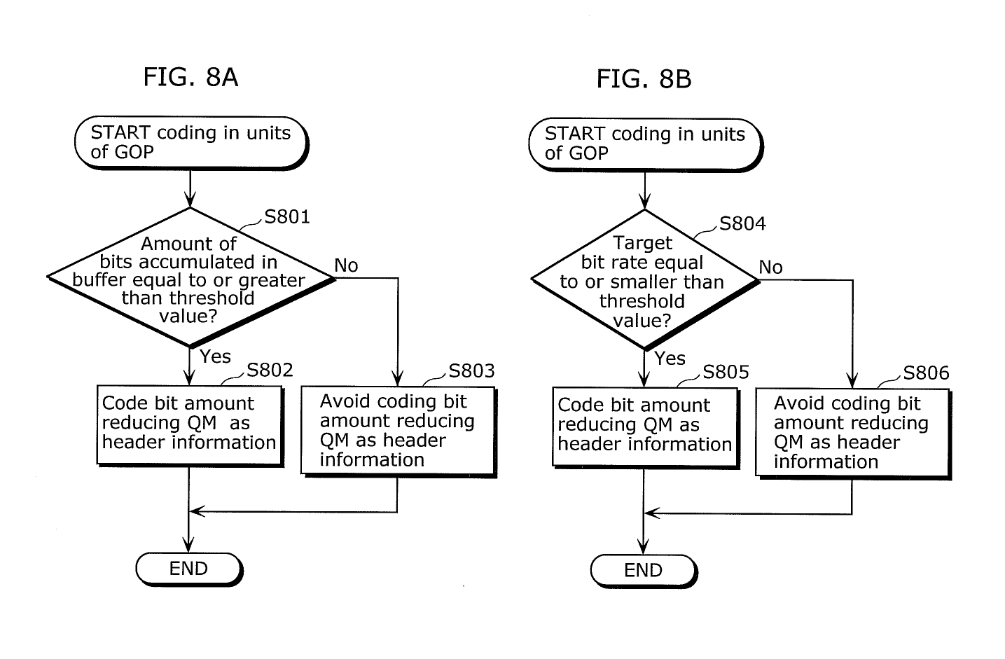

Next, detailed operations performed by the quantization matrix generation unit 708 are described with reference to FIGS. 8A and 8B.

FIG. 8A is a flowchart showing an exemplary method of controlling whether or not to generate a bit amount reducing QM using the amount of bits accumulated in the buffer. It is assumed here that the rate control unit 707 has calculated the amounts of bits accumulated in the buffer, using the amount of bits of data outputted in form of already coded pictures.

First, the quantization matrix generation unit 708 determines whether or not the amount of bits accumulated in the buffer is equal to or greater than the predetermined threshold value (S801). In the case where the amount of bits accumulated in the buffer is equal to or greater than the predetermined threshold value (Yes in S801), the quantization matrix generation unit 708 determines that there is a possibility that a picture for which a bit amount reducing QM is selected and used for the coding appears in the middle of a current GOP to be coded. Next, the quantization matrix generation unit 708 generates the bit amount reducing QM, and outputs the generated bit amount reducing QM to the bit stream generation unit 106. The bit stream generation unit 106 codes the bit amount reducing QM in form of a PPS that is header information at the beginning of the GOP (S802). In other words, the bit stream generation unit 106 stores the bit amount reducing QM in the header part of the GOP.

In the case where the amount of bits accumulated in the buffer is smaller than the threshold value (No in S801), the quantization matrix generation unit 708 determines that there is no possibility that a picture for which a bit amount reducing QM is selected and used for the coding appears in the middle of a current GOP to be coded. Next, the quantization matrix generation unit 708 generates only normal QMs without generating any bit amount reducing QM. Accordingly, the bit stream generation unit 106 codes only the normal QMs without coding any bit amount reducing QM in form of a PPS that could be header information at the beginning of the GOP (S803).

The aforementioned processing is executed at the time of starting coding a control target group such as a GOR The aforementioned processing executed at the time of starting coding a control target group such as a GOP is the same in FIG. 8B.

In addition, the threshold value used for determining whether or not to generate a bit amount reducing QM (generation determination threshold value) as shown in FIG. 8A is preferably smaller than the threshold value used for determining whether or not to use a bit amount reducing QM (use determination threshold value) shown in FIG. 4A. In other words, in order to prevent buffer overflow, the moving picture coding device 700 in Embodiment 2 generates a bit amount reducing QM based on the generation determination threshold value in preparation for possible buffer overflow. Furthermore, the moving picture coding device 700 can use the bit amount reducing QM based on the use determination threshold value higher than the generation determination threshold value in preparation for probable buffer overflow.

As described above, the quantization matrix generation unit 708 determines whether or not to generate a bit amount reducing QM, based on the amount of bits accumulated in the buffer, and generates the bit amount reducing QM only when the quantization matrix generation unit 708 determines that the bit amount reducing QM should be generated. As shown in FIG. 8B, the quantization matrix generation unit 708 may determine whether or not to generate a bit amount reducing QM, based on an output bit rate.

FIG. 8B is a flowchart indicating an exemplary method of controlling whether or not to generate a bit amount reducing QM using an output bit rate of the bit stream that is outputted by the bit stream generation unit 106. The output bit rate is calculated, at the time of starting coding, depending on specified information such as the amount of bits for the bit stream that is outputted by the bit stream generation unit 106 per unit of time.

First, the quantization matrix generation unit 708 determines whether or not the output bit rate is smaller than the predetermined threshold value (S804). In the case where the output bit rate is equal to or smaller than the threshold value (Yes in S804), the quantization matrix generation unit 708 determines that coding must be performed with a low bit rate, and thus that the amount of bits accumulated in the buffer is likely to increase in a short time.

In this case, there is a possibility that a picture for which a bit amount reducing QM is selected and used for the coding appears in the middle of a current GOP to be coded. Therefore, the quantization matrix generation unit 708 generates the bit amount reducing QM, and outputs the generated bit amount reducing QM to the bit stream generation unit 106. The bit stream generation unit 106 codes the bit amount reducing QM in form of a PPS that is header information at the beginning of the GOP (S805).

In the case where the output bit rate is greater than the threshold (No in S804), the quantization matrix generation unit 708 determines that coding is performed with a high bit rate, and thus that the amount of bits accumulated in the buffer is unlikely to increase. In this case, there is no possibility that a picture for which a bit amount reducing QM is selected and used for the coding appears in the middle of a current GOP to be coded. Therefore, the quantization matrix generation unit 708 generates only the normal QMs without generating any bit amount reducing QM. Accordingly, the bit stream generation unit 106 codes only the normal QMs without coding any bit amount reducing QM in form of a PPS that could be header information at the beginning of the GOP (S806).

For this, in the case where there is no possibility that a bit amount reducing QM is used within a current GOP to be coded, no bit amount reducing QM is coded and included in header information at the beginning of the GOP, thereby making it possible to perform suppression so as to prevent unnecessary increase in the amount of bits to be generated.

Here, it is possible to perform control, selectively using one of the processes described with reference to FIGS. 8A and 8B, or using a combination of the both.

### Embodiment 3

In Embodiments 1 and 2, the bit amount reducing QMs generated by a corresponding one of the quantization matrix generation units 108 and 708 are set as predefined constant value matrices. However, the amounts of bits accumulated in the buffer change as current moving pictures to be inputted change. The amounts of accumulated bits are generated by the rate control unit 707. Along this, it is preferable that the bit amount reducing QM is modified suitably for each GOR

For this, in Embodiment 3, the quantization matrix generation unit generates, for each of GOPs, a bit amount reducing QM having a set of coefficient values different from a set of coefficient values of any other one of the QMs, based on the result of buffer simulation.

Next, a moving picture coding device according to Embodiment 3 is described with reference to the drawings.

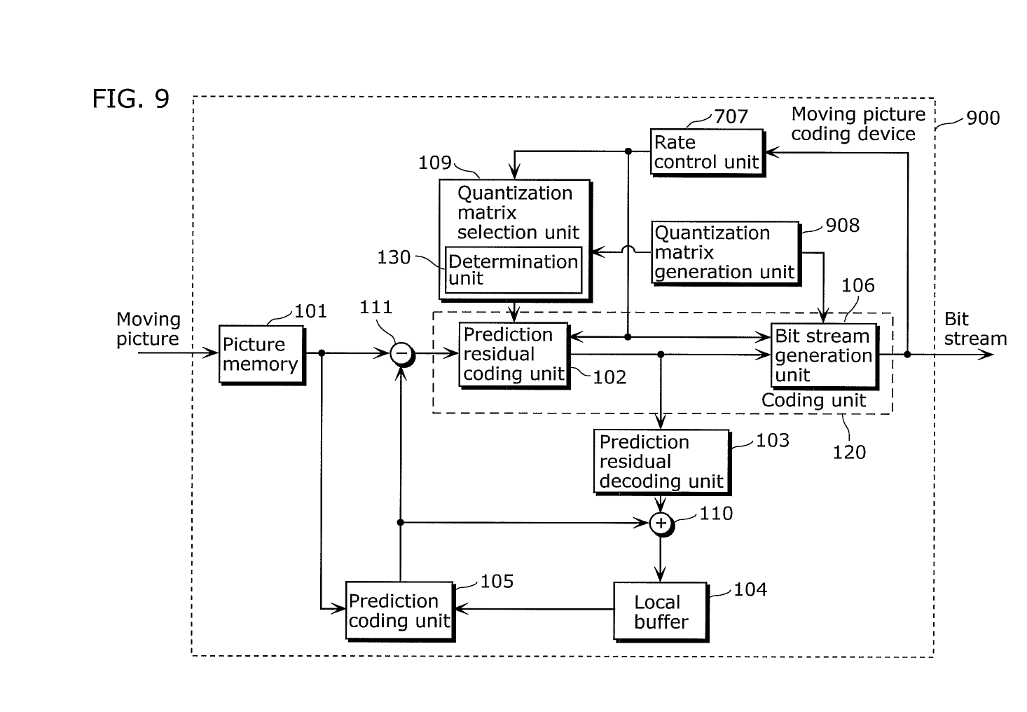

FIG. 9 is a block diagram showing an exemplary structure of the moving picture coding device 900 in Embodiment 3.

The moving picture coding device 900 shown in FIG. 9 differs from the moving picture coding device 700 shown in FIG. 7 in the point of including a quantization matrix generation unit 908 instead of the quantization matrix generation unit 708. In other words, the moving picture coding device 900 in Embodiment 3 differs from the moving picture coding device 700 in Embodiment 2 in the point that the quantization matrix generation unit 908 modifies, for each GOP, the coefficient values of the bit amount reducing QM generated by the quantization matrix generation unit 908.

The same structural elements as those in Embodiments 1 and 2 are assigned with the same reference numerals, and descriptions therefor are omitted. The following descriptions are focused on the differences.

The quantization matrix generation unit 908 generates a bit amount reducing QM having coefficient values that are modified depending on information generated by the rate control unit 707. The other operations by the quantization matrix generation unit 908 are the same as those performed by the quantization matrix generation units 108 and 708 in Embodiments 1 and 2, respectively, and thus the same descriptions are not repeated here.

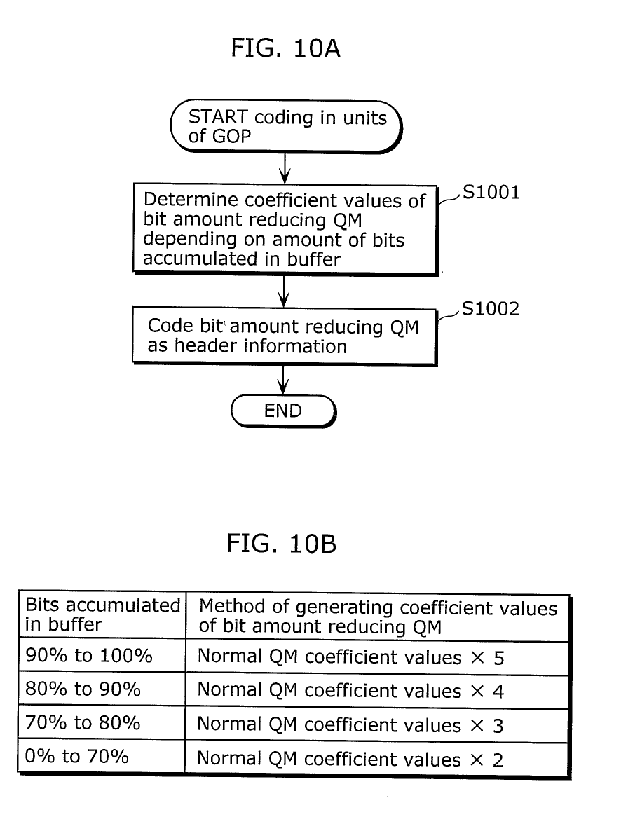

Next, detailed operations performed by the quantization matrix generation unit 908 are described with reference to FIGS. 10A and 10B.

FIG. 10A is a flowchart indicating how the quantization matrix generation unit 908 generates a bit amount reducing QM while modifying the coefficient values.

First, the quantization matrix generation unit 908 determines coefficient values of the bit amount reducing QM using the amount of bits accumulated in the buffer and calculated by the rate control unit 707 (S1001). FIG. 10B shows an exemplary method of determining coefficient values.

As shown in FIG. 10B, in an exemplary case where the amount of bits accumulated in the buffer is within the range from 90 to 100% of the upper limit value for the buffer, the quantization matrix generation unit 908 sets the values obtained by multiplying the respective coefficients in the normal QM by 5 as the coefficient values of the bit amount reducing QM. In addition, in an exemplary case where the amount of bits accumulated in the buffer is within the range from 70 to 80% of the upper limit value for the buffer, the quantization matrix generation unit 908 sets the values obtained by multiplying the respective coefficients in the normal QM by 3 as the coefficient values of the bit amount reducing QM.

In short, the quantization matrix generation unit 908 generates a bit amount reducing QM having larger coefficient values as the amount of bits accumulated in the buffer increases. In contrast, the quantization matrix generation unit 908 generates a bit amount reducing QM having smaller coefficient values as the amount of bits accumulated in the buffer decreases.

In this way, the bit stream generation unit 106 codes the generated bit amount reducing QM in form of a PPS included in header information at the beginning of the GOP (S1002).

By the above-described operations, the moving picture coding device 900 can set a bit amount reducing QM that is determined depending on the amount of bits accumulated in the buffer at the time of starting coding a current GOP, and that drastically reduces the amount of bits in the case where the buffer is likely to overflow. In contrast, the moving picture coding device 900 can selectively use a QM that gradually reduces the amounts of bits to be generated in the case where the buffer has space sufficient to prevent buffer overflow.

For this, it is possible to gradually reduce the amounts of bits to be generated. Thus, the image quality gradually deteriorates instead of deteriorating suddenly even in the case where a complicated image is inputted. This makes it possible to generate a natural-look image.

Here, it is possible to perform control either (i) using the processes described with reference to FIGS. 10A and 10B separately from the processes described with reference to FIGS. 8A and 8B, or (ii) using a combination of arbitrarily selected ones of the processes in FIGS. 8A and 8B and in FIGS. 10A and 10B.

For example, in the case where the threshold value for the amount of bits accumulated in the buffer in FIG. 8A is set to be 60% of the upper limit for the buffer, the combination does not involve generating a bit amount reducing QM in the case where the amount of bits accumulated in the buffer is within a range from 0 to 60% under the condition that the control in the example shown in FIG. 10B is performed. Meanwhile, in the case where the amount of bits accumulated in the buffer is within a range from 60 to 70%, the combination involves generating a bit amount reducing QM having coefficient values obtained by multiplying the coefficient values of the normal QM by 2. Likewise, in the case where the amount of bits accumulated in the buffer is in a range exceeding 70%, the combination involves generating a bit amount reducing QM having coefficient values according to the percentage of the amount of bits accumulated in the buffer. In this way, it is possible to perform control that can provide both the advantageous effects described in Embodiments 2 and 3.

Here, it is possible to perform control either (i) using each of the processes described in Embodiments 2 and 3 separately from each of the processes described in Embodiment 1, or (ii) using a combination of arbitrarily selected ones of the processes in Embodiments 2 and 3 and in Embodiment 1.

### Embodiment 4

In Embodiments 1 to 3, quantization matrices are generated for each GOP, and stored in the header part of the GOR However, it is possible to perform control not only for each GOP control, but also, for example, for a basic unit (a control target group) that is the whole or a part of a moving picture stream to be inputted.

For example, in the case where control is performed for the whole moving picture stream to be inputted, quantization matrices are generated at the time of staring coding the moving picture stream, and the quantization matrices are stored only in the header part of the moving picture.

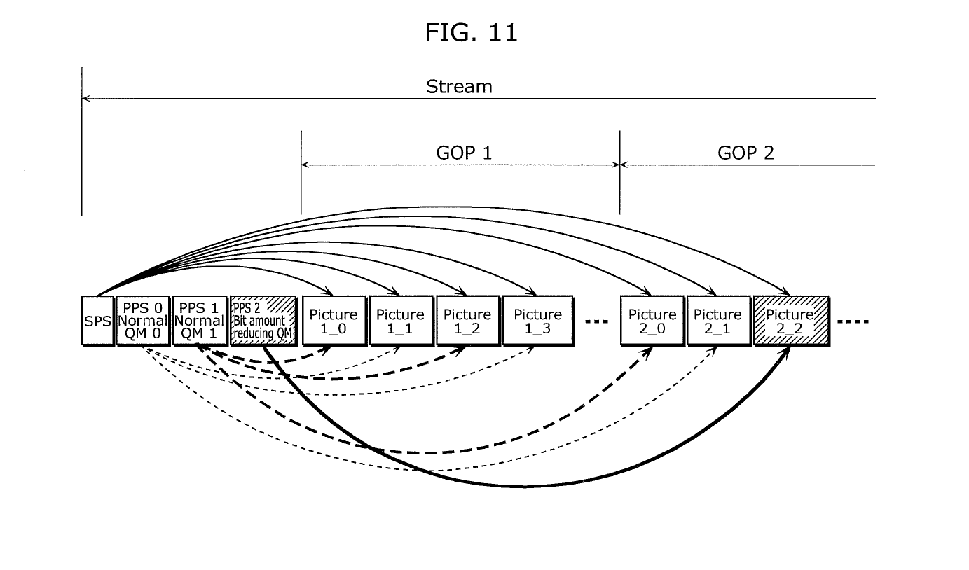

FIG. 11 is a diagram showing a structure of a bit stream in Embodiment 4. Here, SPS, PPS 0, PPS 1, and PPS 2 are written only at the beginning parts, and are used for coding in common for the plural GOPs. Bit amount reducing is determined to be required for Picture2_2 in a GOP 2, and thus PPS 2 that is a bit amount reducing QM is used.

In addition, in the case where a moving picture part such as plural GOPs are used as basic units for such control, quantization matrices are generated in the header part of a first GOP among the plural GOPs.

Methods of generating and selecting one of the quantization matrices are not described in detail here because already provided Embodiments 1 to 3 can be interpreted as describing these methods if “a GOP” therein is modified into “the whole moving picture” or “plural GOPs”.

The moving picture coding devices and moving picture coding methods according to the present invention have been described based on the above Embodiments, but the present invention is not limited to these Embodiments. Those skilled in the art will readily appreciate that many modifications are possible in the exemplary Embodiments and many combinations of the structural elements in these Embodiments are also possible without materially departing from the novel teachings and advantages of the present invention. Accordingly, all such modifications and combinations are intended to be included within the scope of this invention.

### (Other Implementations)

The present invention can be implemented as a computer-readable program product that is a recording medium such as a flexible disc on which a computer-readable program is pre-recorded. The program is intended to implement the functions equivalent to the functions of the structural units included in the moving picture coding devices shown in Embodiments 1 to 4. The program product causes, when loaded onto a computer in an independent computer system, the computer to easily execute the processes described in the respective Embodiments. The recording medium is not limited to a flexible disc, and any other writable recording media such as an optical disc, an IC card, and a ROM cassette are possible.

The present invention may be implemented as an LSI that is an integrated circuit into which the functional blocks equivalent to the respective structural units of the moving picture coding devices described in these Embodiments are integrated. These functional blocks can be in plural single-function LSIs, or also can be in one integrated LSI. The name used here is LSI, but it may also be called IC, system LSI, super LSI, or ultra LSI depending on the degree of integration.

Moreover, ways to achieve integration are not limited to the LSI, and special circuit or general purpose processor and so forth can also achieve the integration. Field Programmable Gate Array (FPGA) that can be programmed after manufacturing LSI or a reconfigurable processor that allows re-configuration of the connection or configuration of LSI can be used for the same purpose.

In the future, with advancement in manufacturing technology, a brand-new technology may replace LSI. The integration can be carried out by that technology.

Furthermore, a broadcast wave from a broadcast station may be compressed, and applied to broadcast wave recording devices such as a DVD recorder and a BD recorder.

### INDUSTRIAL APPLICABILITY

The moving picture coding methods according to the present invention are applicable as methods of generating bit streams by coding each of pictures that constitute each moving picture. These methods can be performed by video cameras, video recorders, DVD devices, mobile phones, personal computers, and the like.

What is claimed is:

1. A moving picture coding device which codes a moving picture in units of a control target group including pictures, said moving picture coding device comprising:
a quantization matrix generation unit configured to generate quantization matrices that are used in quantizing the pictures included in the control target group;
a selection unit configured to select, from among the quantization matrices generated by said quantization matrix generation unit, a quantization matrix that is used in quantizing a current picture to be coded among the pictures;
a coding unit configured to store the quantization matrices generated by said quantization matrix generation unit in a header part of the control target group, and code the current picture to be coded using the quantization matrix selected by said selection unit;
a rate control unit which includes a virtual buffer, and is configured to perform, using said virtual buffer, buffer simulation based on an amount of bits to be outputted by said coding unit; and
a determination unit configured to determine whether or not bit amount reducing is required for the current picture to be coded, based on a result of the buffer simulation performed by said rate control unit,
wherein said quantization matrix generation unit is configured to generate, as the quantization matrices, a normal quantization matrix that is used in common for at least one of the pictures in the control target group, and a quantization matrix for bit amount reducing that is used only when said determination unit determines that the bit amount reducing is required, and
said selection unit is configured to select the quantization matrix for bit amount reducing as the quantization matrix that is used in quantizing the current picture to be coded, when said determination unit determines that the bit amount reducing is required.

2. The moving picture coding device according to claim 1,
wherein said determination unit is configured to determine that the bit amount reducing is required, when an amount of bits accumulated in said virtual buffer is equal to or greater than a predetermined threshold value.

3. The moving picture coding device according to claim 1,
wherein said rate control unit is further configured to generate quantization values that are used in quantizing the current picture to be coded, based on the result of the buffer simulation, and
said determination unit is configured to determine that the bit amount reduction is required, when each of the quantization values generated by said rate control unit is equal to or greater than a predetermined threshold value.

4. The moving picture coding device according to claim 3,
wherein said rate control unit is configured to set, for each of the pictures, a target amount of bits that should be achieved, and
said determination unit is configured to determine that the bit amount reducing is required, when the quantization values generated by said rate control unit are maximum values within a controllable range and when an amount of bits generated by coding at least one of pictures preceding the current picture to be coded is greater than the target amount of bits set by said rate control unit.

5. The moving picture coding device according to claim 1,
wherein said quantization matrix generation unit is further configured to determine whether or not to generate the quantization matrix for bit amount reducing, based on the amount of bits to be outputted by said coding unit, and generate the quantization matrix for bit amount reducing when the quantization matrix for bit amount reducing is determined to be generated.

6. The moving picture coding device according to claim 5,
wherein said quantization matrix generation unit is configured to generate the quantization matrix for bit amount reducing when a bit rate of bits outputted by said coding unit is equal to or smaller than a predetermined threshold value.

7. The moving picture coding device according to claim 5,
wherein said quantization matrix generation unit is configured to generate the quantization matrix for bit amount reducing when the amount of bits accumulated in said virtual buffer is equal to or greater than a predetermined threshold.

8. The moving picture coding device according to claim 1,
wherein said quantization matrix generation unit is configured to generate, for the respective control target groups, quantization matrices for bit amount reducing each having a set of coefficient values that is determined according to an amount of bits accumulated in said virtual buffer and is different from a set of coefficient values of any other one of the quantization matrices for bit amount reducing.

9. The moving picture coding device according to claim 8,
wherein said quantization matrix generation unit is configured to generate the quantization matrices for bit amount reducing such that the sets of coefficient values become larger as the amounts of bits accumulated in said virtual buffer become greater.

10. The moving picture coding device according to claim 8,
wherein said quantization matrix generation unit is configured to generate the quantization matrices for bit amount reducing such that the sets of coefficient values become smaller as the amounts of bits accumulated in said virtual buffer become smaller.

11. The moving picture coding device according to claim 1,
wherein said quantization matrix generation unit is configured to generate the quantization matrix for bit amount reducing such that coefficient values for low frequency components in the quantization matrix for bit amount reducing are twice or more of coefficient values for low frequency components in the normal quantization matrix.

12. A moving picture coding device which codes a moving picture in units of a control target group including pictures, said moving picture coding device comprising:
a quantization matrix generation unit configured to generate quantization matrices that are used in quantizing the pictures included in the control target group;
a selection unit configured to select, from among the quantization matrixes generated by said quantization matrix generation unit, a quantization matrix that is used in quantizing a current picture to be coded among the pictures; and
a coding unit configured to code the current picture to be coded, using the quantization matrix selected by said selection unit,
wherein said quantization matrix generation unit is configured to generate, as the quantization matrices, a normal quantization matrix that is used in common for at least one of the pictures included in the control target group, and a quantization matrix for bit amount reducing that is used only when bit amount reducing is required, and
said coding unit is further configured to store the normal quantization matrix and the quantization matrix for bit amount reducing in a header part of the control target group.

13. A program product causing, when loaded onto a computer, the computer to execute the processing that is executed by each of the processing units included in the moving picture coding device according to claim 1.

14. A broadcast wave recording device which codes, in units of a control target group including pictures, a moving picture broadcast by a broadcasting station, said broadcast wave recording device comprising:
a quantization matrix generation unit configured to generate quantization matrices that are used in quantizing the pictures included in the control target group;
a selection unit configured to select, from among the quantization matrices generated by said quantization matrix generation unit, a quantization matrix that is used in quantizing a current picture to be coded among the pictures;
a coding unit configured to store the quantization matrices generated by said quantization matrix generation unit in a header part of the control target group, and code the current picture to be coded using the quantization matrix selected by said selection unit;
a rate control unit which includes a virtual buffer, and is configured to perform, using said virtual buffer, buffer simulation based on an amount of bits to be outputted by said coding unit; and
a determination unit configured to determine whether or not bit amount reducing is required for the current picture to be coded, based on a result of the buffer simulation performed by said rate control unit,
wherein said quantization matrix generation unit is configured to generate, as the quantization matrices, a normal quantization matrix that is used in common for at least one of the pictures in the control target group, and a quantization matrix for bit amount reducing that is used only when said determination unit determines that the bit amount reducing is required, and
said selection unit is configured to select the quantization matrix for bit amount reducing as the quantization matrix that is used in quantizing the current picture to be coded, when said determination unit determines that the bit amount reducing is required.
